(19) United States
(12) Patent Application Publication
(10) Pub. No.: US 2005/0254829 A1
(43) Pub. Date: Nov. 17, 2005

(54) Status information management system and method for network-based image-forming apparatuses

(75) Inventors: Kang-Hoon Lee, Yongin-si (KR); Gyong-Ock Kim, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/125,203

(22) Filed: May 10, 2005

(30) Foreign Application Priority Data
May 12, 2004 (KR) 2004-33433

(51) Int. Cl. G03G 15/00

(52) U.S. Cl. 399/8

(57) ABSTRACT

Disclosed is a status information management system and method for network-based image-forming apparatuses. The status information management system comprises at least one image-forming apparatus connected to a network, and for printing data transferred through the network; and a web server connected to the image-forming apparatus through the network, and managing operation status information of the image-forming apparatus, wherein the web server creates in advance, lists, and stores a code file corresponding to each operation status of the image-forming apparatus in order to manage the operation status information of the image-forming apparatus. The image-forming apparatus checks its own operation status at predetermined time intervals, searches the web server for a code file corresponding to the operation status, and reads the code file out of the web server. The web server can check the operation status of the image-forming apparatus by checking the code file read out by the image-forming apparatus.

### CROSS-REFERENCE TO RELATED APPLICATION

This application claims the benefit under 35 U.S.C. §119(a) of Korean Patent Application No. 2004-33433, filed on May 12, 2004, in the Korean Intellectual Property Office, the entire content of which is hereby incorporated by reference.

### BACKGROUND OF THE INVENTION

1. Field of the Invention

The present invention relates to a status information management system and method for a network-based image-forming apparatus. More particularly, the present invention relates to status information management system and method capable of managing status information for network-based image-forming apparatuses by using a web server located outside of a firewall.

2. Description of the Related Art

In general, image-forming apparatuses such as printers, multifunction printers, and the like are office machines connected to peripheral devices such as information-processing devices like computers, facsimile machines, or scanners, and have a function of outputting paper printouts. The image-forming apparatus performs this function by receiving documents and image data as print data, converting the print data into a print language suitable for established print conditions, and outputting the documents or image data on paper by using a colored substance such as ink, toner, or the like.

In recent years, low-cost office automation systems are being built by connecting an image-forming apparatus to a network and the like so that plural users can share the apparatus, thereby receiving a cost reduction in consideration of the effectiveness and work efficiency of the apparatus. Such an image-forming apparatus connected to a network and shared by plural users is referred to as a network-based image-forming apparatus.

In general, the network-based image-forming apparatus is connected to plural computers through the local area network (LAN) or the like, and performs print tasks when the plural computers send print data through such a network.

FIG. 1 is a view for explaining a conventional status information management method for a network-based image-forming apparatus. In FIG. 1, the image-forming apparatus such as a printer 20, a multifunction printer 30, and so on, is connected to information-processing devices such as computers, laptop computers, and the like, and peripheral devices such as a facsimile machine, scanner, and the like, through a wireless or a wired communication network, and performs print tasks when the print data is received and are capable of data transmission and reception. The network-based image-forming apparatus provides the printing progress of the print data and the status information such as trouble caused by paper jam, insufficient toner, or the like, to individual devices connected thereto through the network, for the convenience of users using the network-based image-forming apparatus.

The network-based image-forming apparatuses are generally expensive and shared by plural users, so its maintenance such as troubleshooting is important. However, such maintenance is typically serviced by a maintenance service company such as an apparatus manufacturer or the like since there occur various malfunctions that users can not deal with directly.

Therefore, the service company needs to manage the status information of whether or not individual image-forming apparatuses are having malfunctions, and can conveniently and timely provide services if the service company runs a web server having the image-forming apparatuses registered therein and manages the status information of the individual network image-forming apparatuses through a network.

However, most government offices and companies have installed a firewall for security on the network such as the intranet for internal use, and, in such circumstances, the network-based image-forming apparatus can not send its own information outside of the firewall.

The network-based image-forming apparatus of FIG. 1 can broadcast its own status information to individual devices connected inside the intranet, using the simple network management protocol (SNMP), but can not broadcast its own status information outside of the firewall. Further, in order to send the status information of the network-based image-forming apparatus outside of the firewall, a user has to obtain permission from the network security administrator, which is inconvenient.

### SUMMARY OF THE INVENTION

The present invention has been developed in order to solve the above drawbacks and other problems associated with the conventional arrangement. An aspect of the present invention is to provide a status information management system and method for network-based image-forming apparatuses to notify a web server outside a firewall of the status information of a network-based image-forming apparatus and managing the status information of the network-based image-forming apparatus.

The foregoing and other objects and advantages are substantially realized by providing a status information management system for network-based image-forming apparatuses, comprising at least one image-forming apparatus connected to a network, and for printing data transferred through the network; and a web server connected to the image-forming apparatus through the network, and managing the operation status information of the image-forming apparatus, wherein the web server creates in advance, lists, and stores a code file corresponding to each operation status of the image-forming apparatus in order to manage the operation status information of the image-forming apparatus.

The image-forming apparatus may check its own operation status at predetermined time intervals, search the web server for a code file corresponding to the operation status, and read the code file out of the web server.

Further, the web server may create a log file having an IP address of the image-forming apparatus and a name of the code file if the code file is read out thereof, and periodically update the log file.

The web server may create a status file indicating a model number and operation status of the image-forming apparatus by using the log file.

The code file may be generated in the HTML document format.

Another aspect of the present invention is to provide a status information management method for a network-based image-forming apparatus, comprising the steps of creating in advance, listing, and storing by a web server a code file corresponding to each operation status of the image-forming apparatus, wherein the web server is connected to at least one image-forming apparatus through a network; checking the operation status of the image-forming apparatus and reading a corresponding code file out of the web server to the image-forming apparatus; and grasping by the web server the operation status corresponding to the read-out code file and checking operation status information of the image-forming apparatus.

The status information management method may further comprise a step of generating by the web server a log file containing an IP address of the image-forming apparatus and a name of the code file, and the web server periodically may update the log file.

Further, the web server may create a status file containing a model name and the operation status of the image-forming apparatus, and checking the operation status information of the image-forming apparatus according to the status file.

The code file may be generated in the HTML document format.

Accordingly, a system administrator can check in advance and timely manage the operation status of the network-based image-forming apparatus by using the web server outside of the firewall, so that the apparatus is more easily managed and the efficiency of the apparatus can be maximized.

### BRIEF DESCRIPTION OF THE DRAWINGS

The above aspects and features of the present invention will be more apparent by describing certain embodiments of the present invention with reference to the accompanying drawings, in which:

FIG. 1 is a view for explaining a conventional status information management method for a general network-based image-forming apparatus;

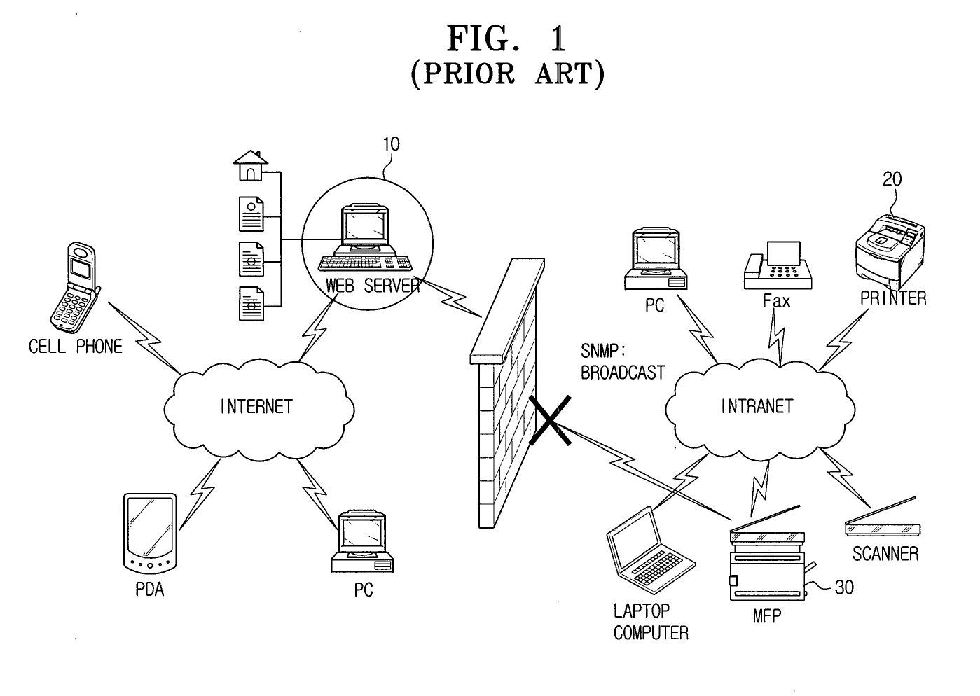

FIG. 2 is a block diagram for schematically showing a status information management system for network-based image-forming apparatuses according to an embodiment of the present invention; and

FIG. 3 is a flow chart for explaining a status information management method for network-based image-forming apparatuses according to an embodiment of the present invention.

Throughout the drawings, it should be understood that like reference numbers refer to like features, structures and elements.

### DETAILED DESCRIPTION OF EXEMPLARY EMBODIMENTS

Hereinafter, the present invention will be described in detail with reference to the accompanying drawings.

The matters defined in the description such as a detailed construction and elements are provided to assist in a comprehensive understanding of the invention. Thus, it is apparent that the present invention can be carried out without those defined matters. Also, well-known functions or constructions are not described in detail for the sake of clarity and conciseness.

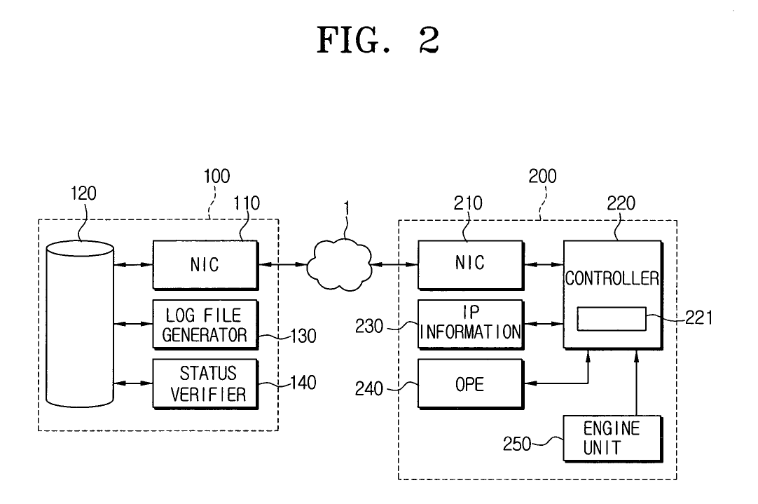

FIG. 2 is a block diagram for schematically showing a status information management system for network-based image-forming apparatuses according to an embodiment of the present invention. In FIG. 2, the status information management system has a web server 100 and an image-forming apparatus 200, and the image-forming apparatus 200 is connected to the web server 100 through the Internet 1.

The web server 100 includes a network card (NIC) 110, a storage unit 120, a log file generator 130, and a status verifier 140. The web server 100 is connected to the Internet 1 through the network card 110 and manages the status information of the image-forming apparatus 200.

The web server 100 stores the IP address of the image-forming apparatus 200, and creates a directory corresponding to the type of the image-forming apparatus 200, and creates and stores in the storage unit 120 code files corresponding to status codes according to all possible operation statuses of the image-forming apparatus 200. That is, the web server 100 lists a status code for each operation status such as ‘busy’, ‘jam paper’, ‘toner low’, and the like, all possible operation statuses occurring during the operations of the image-forming apparatus 200, and generates in listed order and stores code files corresponding to the status codes. A status code is information pre-defined between the web server 100 and the image-forming apparatus 200, and defined as any one of the codes from ‘00000’ to ‘99999’, for example, at a one-to-one match with respect to various operation statuses of the image-forming apparatus 200.

The code files are preferably created as Internet web pages in the Java applet or HTML file format, and, where the status codes of the image-forming apparatus 200 are listed as ‘00000’, ‘00001’, . . . , or ‘99999’, for example, the code file names are preferably set to names corresponding to the status codes, that is, ‘00000.htm’, ‘00001.htm’, . . . , or ‘99999.htm’ in order of the listed status codes.

For example, in case that ‘00000’ is listed when the operation status code of the image-forming apparatus 200 is ‘busy’, ‘00001’ is listed when in ‘paper jam’, and ‘00002’ is listed when in ‘toner low’, the corresponding code file names are set to ‘00000.htm’ for the ‘busy’ status, to ‘00001.htm’ for the ‘paper jam’ status, and to ‘00002.htm’ for the ‘toner low’ status, respectively, and, preferably, code files are accordingly created, listed, and stored in directories according to the model name of the image-forming apparatus.

Further, if a corresponding code file is searched for and read out to the image-forming apparatus 200 depending on the status of the image-forming apparatus 200, the log file generator 130 records in a log file the IP address of the image-forming apparatus 200, a read-out code file name, a directory in which the code file is stored, a read-out time, and the like, and stores the log file in the storage unit 120.

The status verifier 140 looks up the log files stored in the storage unit 120, and checks the operation status of the image-forming apparatus 200. That is, the log file stores the IP address of the image-forming apparatus 200, the read-out code file name, the directory in which the code file is stored, and the read-out time, and the like, so that, if the status code is checked that corresponds to the log file name read out to the image-forming apparatus 200 having the corresponding IP address, the operation status of the image-forming apparatus 200 at the recorded time can be verified.

For example, if the IP address of the image-forming apparatus 200 is ‘123.234.189.000’ and it is recorded that the code file named ‘00001.htm’ was read out at the time of 00:00 on the date of the 0^{th} day of 0^{th} month, year 2004 by the IP address of ‘123.234.189.000’, the status verifier 140 can verifies that the image-forming apparatus 200 was in the ‘paper jam’ status at the time of 00:00 on the date of the 0^{th} day of 0^{th} month, year 2004.

Thus, the status verifier 140 creates a status information file storing status information including the corresponding name of the image-forming apparatus 200, IP address, status, time, model name, and so on, and an administrator can grasp the operation status of the image-forming apparatus 200 with reference to the status information file.

Meanwhile, the image-forming apparatus 200 includes a network card (NIC) 210, a controller 220, an IP information storage unit 230, an operating panel (OPE) 240, and an engine unit 250.

The network card 210 is mounted for communication with other devices connected to a network and the web server 100, but its functions can be incorporated on the board of the network-based image-forming apparatus 200.

The IP information storage unit 230 stores IP information necessary for communication with devices connected to a network and the web server 100. The IP information includes the IP addresses of individual devices connected to the network in the form of ‘000.000.000.000’, for example, and the image-forming apparatus 200 communicates with the individual devices connected to the network by using the IP addresses.

The engine unit 250 prints data delivered from the individual devices of the network. To do this, the engine unit 250 includes a heat lamp (not shown) for heating the heat roller (not shown) and a fuser unit (not shown) having a driving motor (not shown) for driving the heat roller and the fuser roller (not shown), and fixes images, that is, developer, on a sheet of paper at a high temperature and pressure wherein the images correspond to data transferred on the sheet.

Further, the engine unit 250 has a sensing part (not shown) for sensing the operation statuses of the image-forming apparatus 200 indicating the functions that are set for tasks, so as to sense the operation status information of the image-forming apparatus 200 such as paper jams, insufficient toner, insufficient sheets of paper, and so on, and sends the sensed operation status information to the controller 220.

Further, the operating panel 240 is provided with an input unit (not shown) and a display unit (not shown). The input unit (not shown) has a plurality of function keys enabling one to set various functions supported by the image-forming apparatus 200, and the display unit (not shown) is a display device such as LCD, and externally displays the current operation status of the image-forming apparatus 200, and so on. Accordingly, a user checks the current operation status of the image-forming apparatus 200 through the display unit (not shown), and can input a desired IP address, set a desired function of the image-forming apparatus 200, or the like, using the input unit (not shown).

The controller 220 has a buffer 221 for temporarily storing the operation status information of the image-forming apparatus 200 delivered from the engine unit 250 and various data necessary for the operations of the controller 220. The controller 220 controls the overall operations of the printer 100. The controller 220 controls the display unit (not shown) of the operating panel 240 to display the operation status information of the image-forming apparatus 200 transferred from the engine unit 250, and controls the image-forming apparatus 200 to perform desired operations.

Further, the controller 220 outputs the IP address of the web server 100 from the IP information storage unit 230 according to the operation status information of the image-forming apparatus 200 transferred from the sensing unit (not shown) of the engine unit 250, checks the operation status code according to the operation status of the image-forming apparatus 200, searches for a code file corresponding thereto, and takes in the code file from the web server 100.

Accordingly, if the code file is read out of the web server 100, the log file generator 130 of the web server 100 creates a log file including information of the IP address of the image-forming apparatus 200, code file name, read-out time, and so on, and the status verifier 140 generates a status information file by using the log file. The administrator can be aware of the operation status of the image-forming apparatus 200 by checking the status information file generated by the status verifier 140.

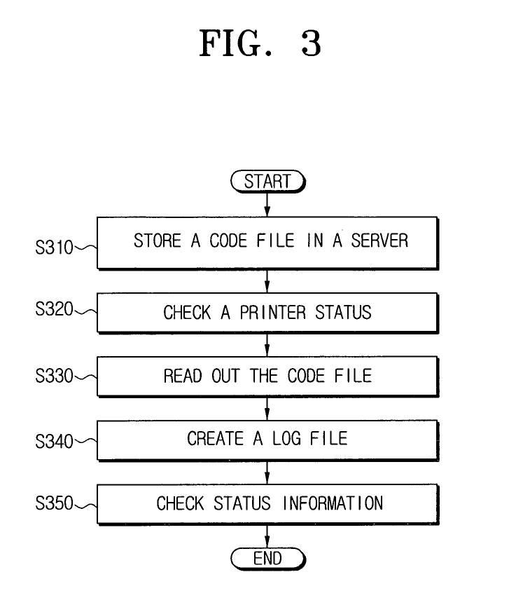

FIG. 3 is a flow chart for explaining a status information method for network-based image-forming apparatuses according to an embodiment of the present invention. First, an IP address of the web server 100 is stored in the image-forming apparatus 200, the IP address of the image-forming apparatus 200 is stored in the web server 100, so information is pre-set that is necessary for communication between the web server 100 and the image-forming apparatus 200 (S310). Further, the web server 100 generates a directory corresponding to the model name of the image-forming apparatus 200, and creates in the directory of the model name code files corresponding to the status codes corresponding to all possible operation statuses of the image-forming apparatus 200. The web server 100 stores the created code files in the storage unit 120.

Next, the operation status occurring during the operation of the image-forming apparatus 200 is sensed, and a corresponding status code is verified by the image-forming apparatus 200 (S320), and, accordingly, a corresponding code file is searched and read out of the web server 100 (S330). It is preferable that the status verification of the image-forming apparatus 200 and the readout of the code file from the web server 100 are periodically performed at predetermined time intervals.

If the code file corresponding to the status code corresponding to the operation status of the image-forming apparatus 200 is searched and read out from the web server 100 into the image-forming apparatus 200, the log file generator 130 of the web server 100 creates a log file in which the IP address of the image-forming apparatus 200 has been stored, the name of the read-out code file, the directory in which the code file is stored, the read-out time, and so on (S340).

Accordingly, the status verifier 140 of the web server 100 refers to the log file stored in the storage unit 120, and checks the operation status information of the image-forming apparatus 200 (S350). That is, the log file records therein the IP address of the image-forming apparatus 200, the name of the read-out code file, the directory the code file is stored in, the read-out time, and so on, so that, if the status code corresponding to the name of the log file read out to the image-forming apparatus 200 having the corresponding IP address is verified, one can readily identify the operation status of the image-forming apparatus 200 occurred at the recorded time.

Therefore, the image-forming apparatus 200 does not have to send information out of the firewall in order to notify the web server 100 of its own operation status, and, by reading out of the web server 100 the code files created corresponding to the status codes corresponding to the various operation statuses of the image-forming apparatus 200, indirectly notifies the web server 100 of its own status information. Thus, the administrator of the image-forming apparatus 200 can identify and troubleshoot the failure of the image-forming apparatus 200 by using the web server 100, enabling a reduction in management cost and time as well as providing effective and timely apparatus management.

Further, the web server 100 can generate directories and code files for a variety of models and manufacturers of the image-forming apparatuses, and manage the status information by model names, for example, of the image-forming apparatuses by applying the present embodiment thereto. Thereby, a database organized by the model names and frequencies of failures of the image-forming apparatuses of different model names can be used to provide timely services necessary for maintenance and after-sales services.

The embodiments of the present invention store in the web server the code files corresponding to the various operation status codes of the image-forming apparatuses, the image-forming apparatus reads out of the web server the code file corresponding to its own operation status, and the web server checks the operation status of the image-forming apparatus by checking the code file that the image-forming apparatus read.

Therefore, the apparatus administrator can check in advance the operation status of the image-forming apparatus and properly manage the image-forming apparatus by using a web server outside of the firewall, so that the apparatus can be conveniently maintained and the efficiency of the apparatus can be maximized.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A status information management system for network-based image-forming apparatuses, comprising:
at least one image-forming apparatus connected to a network, and for printing data transferred through the network; and
a web server connected to the image-forming apparatus through the network, and managing operation status information of the image-forming apparatus, wherein the web server creates in advance, lists, and stores a code file corresponding to each of a plurality of operation statuses of the image-forming apparatus in order to manage the operation status information of the image-forming apparatus.

2. The status information management system as claimed in claim 1, wherein the image-forming apparatus checks its own operation status at predetermined time intervals, searches the web server for a code file corresponding to the checked operation status, and reads the code file out of the web server.

3. The status information management system as claimed in claim 2, wherein the web server creates a log file having an IP address of the image-forming apparatus and a name of the code file if the code file is read out thereof.

4. The status information management system as claimed in claim 3, wherein the web server periodically updates the log file.

5. The status information management system as claimed in claim 3, wherein the web server creates a status file indicating a model number and operation status of the image-forming apparatus by using the log file.

6. The status information management system as claimed in claim 1, wherein the code file is generated in the HTML document format.

7. A status information management method for a network-based image-forming apparatus, comprising steps of:
creating in advance, listing, and storing by a web server a code file corresponding to each operation status of the image-forming apparatus wherein the web server is connected to at least one image-forming apparatus through a network;
checking the operation status of the image-forming apparatus and reading a corresponding code file out of the web server to the image-forming apparatus; and
identifying by the web server the operation status corresponding to the read-out code file and checking the operation status information of the image-forming apparatus.

8. The status information management method as claimed in claim 7, further comprising a step of generating by the web server a log file containing an IP address of the image-forming apparatus and a name of the code file.

9. The status information management method as claimed in claim 8, wherein the web server periodically updates the log file.

10. The status information management method as claimed in claim 8, wherein the web server creates a status file containing a model name and the operation status of the image-forming apparatus, and checking the operation status information of the image-forming apparatus according to the status file.

11. The status information management method as claimed in claim 7, wherein the code file is generated in the HTML document format.
